(19) United States
(12) Patent Application Publication
(10) Pub. No.: US 2018/0211097 A1
(43) Pub. Date: Jul. 26, 2018

(54) METHOD AND DEVICE FOR ACQUIRING FEATURE IMAGE, AND USER AUTHENTICATION METHOD

(71) Applicant: Alibaba Group Holding Limited, Grand Cayman (KY)

(72) Inventor: Zhengbo WANG, Hangzhou (CN)

(21) Appl. No.: 15/880,006

(22) Filed: Jan. 25, 2018

(30) Foreign Application Priority Data
Jan. 26, 2017 (CN) 201710061682.0

(51) Int. Cl. G06K 9/00; G06F 21/32; G06F 17/30

(52) U.S. Cl. CPC G06K 9/00255; G06K 9/00268; G06F 17/30256; G06F 21/32; G06K 9/00288

(57) ABSTRACT

False authentication that is obtained by using a photographic image to impersonate a real human being when being photographed for authentication is prevented by photographing a user's face while illuminated by two different patterns on a display screen to obtain two different images, determining a difference between the two different images to obtain a difference image, and then comparing the difference image to previous images to determine if a real human being is attempting authentication.

### CROSS-REFERENCE TO RELATED APPLICATIONS

This application claims priority to Chinese Patent Application No. 201710061682.0, filed on Jan. 26, 2017, which is incorporated herein by reference in its entirety.

### BACKGROUND OF THE INVENTION

### 1. Field of the Invention

The present application relates to the field of living body recognition and, in particular, to a method for acquiring a facial feature image, a device for acquiring a facial feature image, an acquisition device for a facial feature image, and a user authentication method.

### 2. Description of the Related Art

In the prior art, when a user uses a hand-held smart terminal or desktop computer to use an Internet service, such as logging into an e-mail server or browsing a product details page, some platforms or clients require photographing the user. For example, face photographs of users are collected, and facial feature images of the users are obtained, recorded, and saved, thereby distinguishing users from others and ensuring the security of the Internet service.

One drawback of this approach is that the traditional use of a single camera to photograph a user's face to obtain a facial feature image is vulnerable to deception by using a fake two-dimensional human face image. For example, a photograph taken by an illegal user of a legal user's face image may also be regarded by various platforms or clients as a real human face photograph of the legal user. As a result, the security of the Internet service cannot be guaranteed, becoming an easy target for illegal users.

### SUMMARY

The present invention eliminates false authentications that are obtained by using a photographic image to impersonate a real human being when being photographed for authentication. The present invention includes a method for authentication that includes displaying a first pattern on a display screen. The first pattern on the display screen illuminates an object. The method also includes photographing the object illuminated by the first pattern on the display screen to obtain an initial image of the object. In addition, the method includes displaying a second pattern on the display screen. The second pattern on the display screen illuminates the object. Further, the method includes photographing the object illuminated by the second pattern on the display screen to obtain a changed image of the object, and generating a feature image of the object based on the initial image and the changed image.

The present invention also includes a non-transitory computer-readable medium having computer executable instructions that when executed by a processor cause the processor to perform a method of authentication. The method embodied in the medium includes controlling a display screen to display a first pattern on the display screen. The first pattern on the display screen illuminates an object. The method also includes controlling a camera to photograph the object illuminated by the first pattern on the display screen to obtain an initial image of the object. In addition, the method includes controlling the display screen to display a second pattern on the display screen. The second pattern on the display screen illuminates the object. Further, the method includes controlling the camera to photograph the object illuminated by the second pattern on the display screen to obtain a changed image of the object, and generating a feature image of the object based on the initial image and the changed image.

The present invention further includes a device that includes a display screen, a camera, and a processor that is coupled to the display screen and the camera. The processor to control the display screen to display a first pattern on the display screen. The first pattern on the display screen illuminates an object. The processor to further control the camera to photograph the object illuminated by the first pattern on the display screen to obtain an initial image of the object. In addition, the processor to control the display screen to display a second pattern on the display screen. The second pattern on the display screen illuminates the object. Further, the processor to additionally control the camera to photograph the object illuminated by the second pattern on the display screen to obtain a changed image of the object, and generate a feature image of the object based on the initial image and the changed image.

A better understanding of the features and advantages of the present invention will be obtained by reference to the following detailed description and accompanying drawings which set forth an illustrative embodiment in which the principals of the invention are utilized.

### BRIEF DESCRIPTION OF THE DRAWINGS

In order to illustrate the technical solutions in the embodiments of the present application more clearly, the drawings required for describing the embodiments will be introduced briefly below. Apparently, the drawings described below are merely some embodiments of the present application, and those of ordinary skill in the art can also obtain other drawings according to these drawings without making creative efforts.

FIG. 1 is a diagram illustrating an example of a hand-held smart terminal 101 in accordance with the present invention.

FIG. 2 is a flowchart illustrating an example of a method 200 for acquiring a feature image in accordance with the present invention.

FIG. 3 is a flowchart illustrating an example of a method 300 for acquiring a feature image in accordance with the present application.

FIGS. 4A-4F are photographic images further illustrating method 300 in accordance with the present invention. FIG. 4A is an initial image of a real human face. FIG. 4B is a changed image of the human face. FIG. 4C is a facial feature image which illustrates the differences between the initial image in FIG. 4A and the changed image in FIG. 4B. FIG. 4D is an initial image of a photographed face. FIG. 4E is a changed image of the photographed face. FIG. 4F is a facial feature image which illustrates the differences between the initial image in FIG. 4D and the changed image in FIG. 4E.

FIG. 5 is a block diagram illustrating an example of a facial feature acquisition device 500 in accordance with the present invention.

FIG. 6 is a block diagram illustrating an example of a facial feature acquisition device 600 in accordance with the present invention.

FIG. 7 is a block diagram illustrating an example of a facial feature acquisition device 700 in accordance with the present invention.

FIG. 8 is a flow chart illustrating an example of a method 800 of authenticating a user in accordance with the present invention.

FIG. 9 is a block diagram illustrating an example of a mobile computing apparatus 900 in accordance with the present invention.

### DETAILED DESCRIPTION OF THE INVENTION

The technical solutions in the embodiments of the present application will be described clearly and completely below with reference to the drawings in the embodiments of the present application. It is apparent that the described embodiments are merely some, rather than all of the embodiments of the present application. On the basis of the embodiments in the present application, all other embodiments obtained by those of ordinary skill in the art without making creative efforts shall fall within the protection scope of the present application.

While the concepts of the present application are susceptible to various modifications and alternative forms, specific embodiments thereof have been shown by way of example in the drawings and will be described herein in detail. It should be understood, however, that there is no intent to limit the concepts of the present application to the particular forms disclosed, but on the contrary, the intent is to cover all modifications, equivalents, and alternatives consistent with the present application and the appended claims.

References in the specification to “one embodiment,” “an embodiment,” “an illustrative embodiment,” and so on indicate that the embodiment described may include a particular feature, structure, or characteristic, but every embodiment may or may not necessarily include the particular feature, structure, or characteristic. Moreover, such phrases are not necessarily referring to the same embodiment. Further, when a particular feature, structure, or characteristic is described in connection with an embodiment, it is believed that it is within the knowledge of those skilled in the art to effect such feature, structure, or characteristic in connection with other embodiments whether or not explicitly described. Besides, it should be understood that items included in a list in the form “at least one of A, B, and C” may represent (A); (B); (C); (A and B); (A and C); (B and C); or (A, B, and C). Similarly, items listed in the form “at least one of A, B, or C” may represent (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (for example, computer-readable) storage media, which may be read and executed by one or more processors. A machine-readable storage medium may be embodied as any storage apparatus, mechanism, or apparatus of other physical structure for storing or transmitting information in a machine-readable form (for example, a volatile or non-volatile memory, a media disc, or other media).

In the drawings, some structural or method features may be shown in specific arrangements and/or orderings. However, it should be understood that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

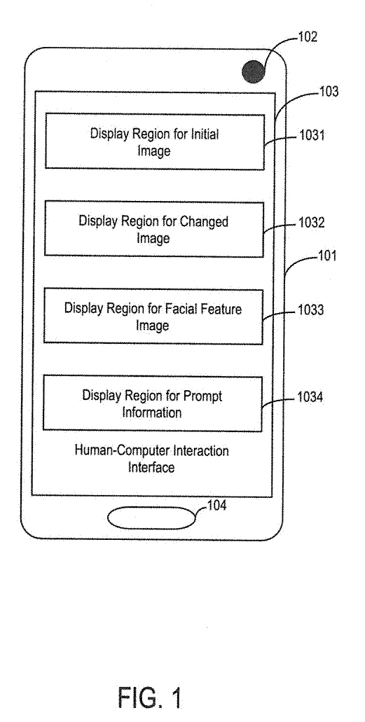

FIG. 1 shows a diagram that illustrates an example of a hand-held smart terminal 101 in accordance with the present invention. As shown in FIG. 1, smart terminal 101 includes a camera 102, a display screen 103 that provides a man-machine interface, and a touch button 104 that along with display screen 103 allows a user to interact with smart terminal 101.

Although FIG. 1 illustrates a hand-held smart terminal, embodiments of the present application may also be applied to a personal computer (PC), an all-in-one computer, or the like having a camera, as long as the personal computer (PC) or all-in-one computer has a camera and is integrated with an acquisition device in the present application. According to another embodiment of the present application, the smart terminal may be installed with application software, and the user may interact with the application software through an interaction interface of the application software. Reference is made to the following embodiments for further detailed description of FIG. 1.

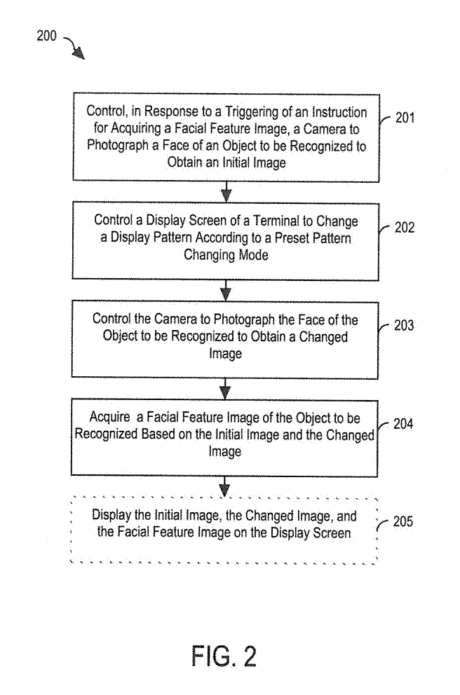

FIG. 2 shows a flowchart that illustrates an example of a method 200 for acquiring a feature image in accordance with the present invention. The solution provided in this embodiment may be applied to a server or a terminal. When the solution is applied to a server, the server is connected to a terminal used by a user. The terminal, in turn, has an installed camera. When the solution is applied to a terminal, the terminal also has an installed camera. Using a smart phone that has an installed camera as an example, method 200 includes the following steps:

Step 201: Control, in response to a triggering of an instruction for acquiring a facial feature image, the camera of the smart phone to photograph a face of an object to be recognized to obtain an initial image.

In this embodiment, the smart phone is integrated with an acquisition function. The acquisition function may be used as a new function of an existing APP, or may be used as an independent APP to be installed on the smart phone. The acquisition function can provide a man-machine interaction interface on which the user can trigger an instruction, for example, for acquiring a facial feature image or other types of biological feature images. Specifically, the instruction may be triggered by clicking a button or a link provided on the human-computer interaction interface. Using an instruction for acquiring a facial feature image as an example, after receiving the instruction for acquiring a facial feature image, the acquisition function controls a camera installed on the smart phone to photograph the user's face for the first time, and an initial image can be obtained if the photographing is successful.

In one embodiment, the process of photographing the user's face to obtain an initial image includes step A1 to step A3.

Step A1: Generate an initial pattern to be displayed on a display screen of the smart phone according to a preset two-dimensional periodical function.

In this embodiment, the initial pattern is displayed on the display screen of the smart phone, and the user's face is photographed to obtain an initial image while the initial pattern irradiates the user's face. In actual application, the initial pattern may be a regularly changing pattern or an irregularly changing pattern, for example, a wave pattern or a checkerboard pattern.

In this example, the initial pattern to be displayed on the display screen may be generated according to a preset two-dimensional periodical function. Specifically, the periodicity of the initial pattern may be represented using the function shown in Equation 1:

$$c ( i , j , {N}_{i} , {N}_{j} , {φ}_{i} , {φ}_{j} ) = cos ( \frac{2 π i}{{N}_{i}} + {φ}_{i} ) cos ( \frac{2 π j}{{N}_{j}} + {φ}_{j} ) \qquad ( 1 )$$

i is a transverse pixel number of the display screen, and j is a longitudinal pixel number. In actual application, a leftmost and uppermost pixel on the display screen may be taken as (i,j)=(0,0), and Nᵢ,Nⱼ are respectively periods in transverse and longitudinal directions, and then φᵢ, φⱼ are respectively initial phases in the transverse and longitudinal directions.

Step A2: Control the initial pattern to be displayed on the display screen according to a preset color channel.

Then, a specific initial pattern may be generated according to the two-dimensional periodical function c(i, j, Nᵢ, Nⱼ, ϕᵢ, ϕⱼ) shown in Equation 1. For example, c(i,j) is substituted into a function f to obtain ƒ(c(i,j)). Specifically, c(i, j) is substituted into ƒ(x)=A(1+x)+B to generate a wave pattern, while c(i,j) is substituted into ƒ(x)=A(1+sign(x))+B to generate a checkerboard pattern, where A and Bin the equations are constants herein. It can be understood that the form of the function ƒ(x) is not limited to these two functions. After the initial pattern is obtained, the initial pattern ƒ(c(i,j)) may be then independently displayed using one or more color channels, for example, gray scale, a single RGB color channel, or multiple RGB color channels.

Step A3: Control the camera to photograph the face of the object to be recognized to obtain the initial image under irradiation of the initial pattern.

After the display screen of the smart phone displays the initial pattern, the camera is controlled to photograph the user's face to acquire an initial image under irradiation of the initial pattern, where the initial image is an original facial image of the user.

Step 202: Control a display screen of the terminal to change a display pattern according to a preset pattern changing mode.

In this embodiment, in order to accurately know the shadow change of the user's face under irradiation of different display patterns, the display screen of the smart phone is controlled to change the display pattern according to a preset pattern changing mode after the initial image is irradiated for the first time. Specifically, the display pattern may be changed by shifting the phase, which changes the phase without changing the frequency.

In one embodiment, the process of changing a display pattern in this step includes step B1 to step B2.

Step B1: Perform phase inversion on the initial image to obtain a changed pattern.

In order to highlight the change of light and shade on features on the user's face under irradiation of different display patterns, a phase inversion operation may be performed on the initial pattern in step 202 in this example, where the spatial frequency may remain consistent with that of the initial pattern, so as to obtain a changed display pattern.

Step B2: Control the changed pattern to be displayed on the display screen according to the preset color channel.

Then, the changed display pattern is controlled to be displayed on the display screen of the smart phone according to a color channel the same as that in step A2, so that the changed pattern also irradiates the user's face.

Step 203: Control the camera to photograph the face of the object to be recognized to obtain a changed image.

Then, in the case that the changed pattern irradiates the user's face, the camera is controlled to photograph the user's face for a second time, so as to obtain a changed image including the initial facial image of the user under the changed pattern.

Step 204: Acquire a facial feature image of the object to be recognized based on the initial image and the changed image.

Since the changed image is an image obtained by photographing the user's face while phase inversion is performed on the initial image, a differential image can be obtained by using the initial image and the changed image, so as to obtain features of the user's face.

Specifically, the process of obtaining a facial feature image of the user may be calculating a difference between the changed image and the initial image. That is, subtracting pixel values of the initial image from corresponding pixel values of the changed image to obtain a differential image, and then determining the differential image obtained by the differencing operation as the facial feature image of the object to be recognized.

Step 205: Display the initial image, the changed image, and the facial feature image on the display screen.

After the facial feature image of the user has been obtained, the initial image, the changed image, and the facial feature image may be further displayed on the display screen of the smart phone, so that the user can see his own original facial image and the facial feature image. Specifically, the initial image may be displayed in a “Display region for initial image” 1031 shown in FIG. 1, the changed image may be displayed in a “Display region for changed image” 1032 shown in FIG. 1, and the facial feature image may be displayed in a “Display region for facial feature image” 1033.

Hence, the embodiment of the present application utilizes the fact that, in the case that a display pattern of a display screen changes, since features on a user's face have characteristics such as different heights and different positions, different characteristics reflect different shadow characteristics in response to the change of the display pattern, so as to obtain a facial feature image capable of reflecting unique facial characteristics of the user. Further, the facial feature image may also be provided to the user to improve user experience.

In actual application, the aforementioned method for acquiring a feature image may be applied to the technical field of living body recognition. For example, living body recognition is performed on a user by using the facial feature image obtained in step 204, so as to recognize a real human based on the characteristic that real human facial organs have shadow features to be distinguished from a face photograph of the user, thereby improving the efficiency of living body recognition.

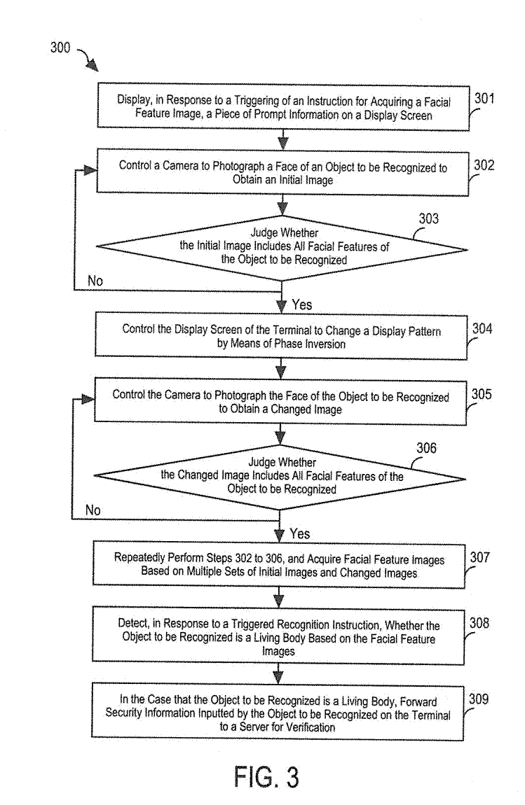

FIG. 3 shows a flowchart that illustrates an example of a method 300 for acquiring a feature image in accordance with the present application. Using a smart phone that has an installed camera as an example, method 300 includes the following steps.

Step 301: Display, in response to a triggering of an instruction for acquiring a facial feature image, a piece of prompt information on the display screen, where the prompt information is used for reminding the object to be recognized to remain still.

In this embodiment, after a user triggers an instruction for acquiring a facial feature image, a piece of prompt information may be displayed on the display screen, wherein the prompt information is used for reminding the user to remain still, so that the camera can focus on and photograph the user's face. Specifically, the prompt information may be displayed in a “Display region for prompt information” 1034 shown in FIG. 1.

Step 302: Control the camera to photograph a face of the object to be recognized to obtain an initial image.

Reference may be made to the detailed introduction to the embodiment shown in FIG. 2 for the specific implementation of step 302, details of which are omitted to avoid repetition.

Step 303: Judge whether the initial image includes facial characters of the object to be recognized. If so, perform step 304. If not, return to step 302.

After the user has been photographed for the first time to obtain an initial image, it may be further judged whether the initial image obtained by photographing includes key facial characters of the user. For example, whether the initial image includes the eyes, nose, eyebrows, mouth, and left and right cheeks of the user. Only when an initial image includes key facial features capable of reflecting basic facial characters of a user can the initial image be used. If the initial image does not include the key facial features, the flow returns to step 302 to again photograph the user to obtain an initial image, and continue until the initial image meets the requirement.

Step 304: Control a display screen of the terminal to change a display pattern by means of phase inversion.

Step 305: Control the camera to photograph the face of the object to be recognized to obtain a changed image.

Reference may be made to the detailed introduction to the embodiment shown in FIG. 2 for the specific implementation of step 304 and step 305, details of which are omitted to avoid repetition.

Step 306: Judge whether the changed image includes key facial characters of the object to be recognized. If so, move to step 307 to repeatedly perform step 302 to step 306 to acquire multiple sets of corresponding initial images and changed images and, if not, return to step 305.

After the changed image is obtained, it may be further judged whether the changed image includes key features on the user's face in the manner described in step 303. If yes, it indicates that this changed image has also been successfully photographed, and then the flow returns to step 302, and step 302 to step 305 are repeatedly performed many times so as to obtain multiple sets of corresponding initial images and changed images. If the changed image does not include key features on the user's face, it indicates that the changed image has not been successfully photographed, and then the flow returns to step 305 to photograph the user's face again.

Step 307: Acquire multiple facial feature images of the object to be recognized based on the multiple sets of initial images and changed images.

In this step, calculation is performed on the multiple sets of initial images and changed images obtained by photographing many times, so as to obtain multiple facial feature images. For example, a total of five sets of initial images and changed images are obtained by photographing the facial features. Following this, pixel value subtraction is performed on each set of initial image and changed image so as to obtain five differential images as five facial feature images of the user.

Step 308: Detect, in response to a triggered recognition instruction, whether the object to be recognized is a living body based on the multiple facial feature images.

Further, whether the object to be recognized is a living body can be detected based on the multiple facial feature images in step 307. For example, the multiple facial feature images may be averaged to obtain an average facial feature image as a basis for detection, or the multiple facial feature images may be separately used for detection and multiple detection results are synthesized to obtain a final detection result.

Specifically, a classifier capable of representing facial characteristics of a user may be pre-trained. For example, the classifier can be trained using various distribution characteristics of features on a human face. Specifically, upon comparison between human eyes and nose, the eyes are generally at a higher position than the nose, while the mouth is generally positioned below the nose, i.e., in the lowest part of the face, so when a human face is photographed, the nose part generally produces a shadow due to its high position, while cheeks on two sides of the nose can be bright due to strong light. The features on the human face may be analyzed to train a classifier.

Then, after a facial feature image of the user is obtained, the facial feature image may be inputted into the classifier to obtain a detection result. During specific detection, the classifier may obtain a detection result based on whether shadow features shown in the facial feature image are consistent with facial characteristics of a living body trained in the classifier. If they are consistent, it indicates that the object photographed is a living body. If they are not consistent, it indicates that the object photographed may be a photograph, and not a human face.

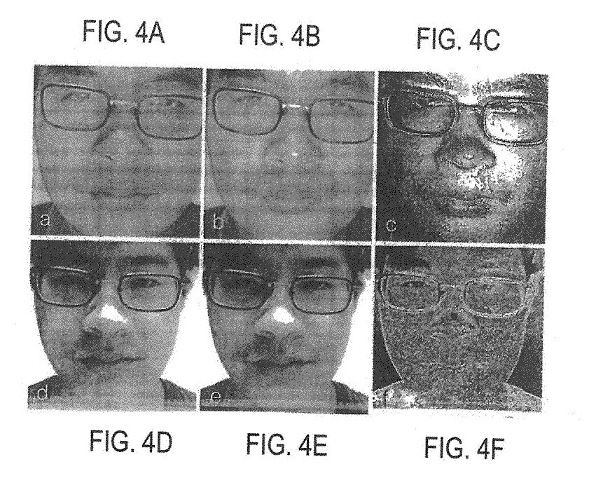

FIGS. 4A-4F show photographic images that further illustrate method 300 in accordance with the present invention. FIG. 4A is an initial image of a real human face, while FIG. 4B is a changed image of the human face and FIG. 4C is a facial feature image which illustrates the differences between the initial image in FIG. 4A and the changed image in FIG. 4B. FIG. 4C illustrates shadow features exclusively belonging to human facial characteristics based on the differences between FIGS. 4A and 4B.

FIG. 4D is an initial image of a photographed face, while FIG. 4E is a changed image of the photographed face and FIG. 4F is a facial feature image which illustrates the differences between the initial image in FIG. 4D and the changed image in FIG. 4E. FIG. 4F illustrates the absence of shadow features from human facial characteristics.

Step 309: In the case that the object to be recognized is a living body, forward security information inputted by the object to be recognized on the smart phone to a server for verification.

Further, if it is detected that the object operating the smart phone is a real human, security information such as a login account and a login password inputted by the user may be received through a human-computer interaction interface, and the security information is sent to a server for verification. If the verification is successful, a data processing request, for example, an operation such as password change or fund transfer of the user is sent to the server. If the verification fails, the data processing request of the user may be ignored.

In this embodiment, multiple sets of initial images and changed images may be collected to obtain multiple facial feature images to perform living body detection, so that the accuracy of living body detection is improved and objects to be recognized being human face photographs can be filtered out, thereby ensuring the security of network data.

In order to describe the foregoing method embodiments in a concise manner, all the method embodiments are expressed as a combination of a series of actions; but those skilled in the art should know that the present application is not limited by the sequence of the described actions. Certain steps can adopt other sequences or can be carried out at the same time according to the present application. Secondly, those skilled in the art should also know that all the embodiments described in the specification are preferred embodiments, and the related actions and modules are not necessarily required for the present application.

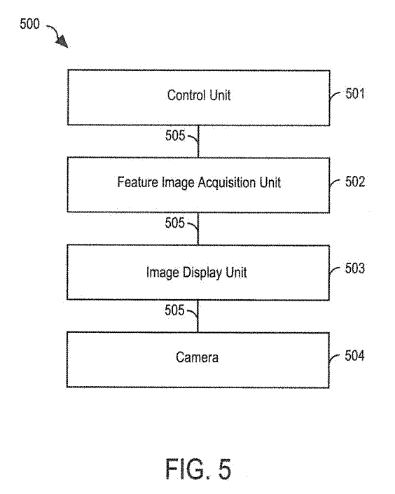

FIG. 5 shows a block diagram that illustrates an example of a facial feature acquisition device 500 in accordance with the present invention. As shown in FIG. 5, facial acquisition device 500 includes a control unit 501, a feature image acquisition unit 502, an image display unit 503 that provides a man-machine interface, a camera 504, and a bus 505 that couples control unit 501 to acquisition unit 502, display unit 503, and camera 504.

Control unit 501 is configured to control, in response to a triggering of an instruction for acquiring a facial feature image, camera 504 to photograph a face of an object to be recognized to obtain an initial image. Control unit 501 is also configured to control a display screen of display unit 503 to change a display pattern according to a preset pattern changing mode, and control camera 504 to photograph the face of the object to be recognized to obtain a changed image.

To obtain the initial image, control unit 501 generates an initial pattern to be displayed on the display screen of display unit 503 according to a preset two-dimensional periodical function. In addition, control unit 501 controls the initial pattern to be displayed on the display screen of display unit 503 according to a preset color channel, and controls camera 504 to photograph the face of the object to be recognized to obtain the initial image under irradiation of the initial pattern.

To obtain the changed image, control unit 501 generates a changed pattern to be displayed on the display screen of display unit 503. Control unit 501 performs phase inversion on the initial image to obtain the changed pattern. Further, control unit 501 controls the changed pattern to be displayed on the display screen according to the preset color channel.

Control unit 501 can be further configured to judge whether the initial image includes key facial features of the object to be recognized. If so, control unit 501 is configured to perform the step of controlling the display screen of display unit 503 to change a display pattern according to a preset pattern changing mode. If not, control unit 501 is configured to perform the step of controlling camera 504 to again photograph the face of an object to be recognized to obtain an initial image.

Control unit 501 can be further configured to judge whether the changed image includes key facial features of the object to be recognized. If so, control unit 501 is configured to perform the step of acquiring a facial feature image of the object to be recognized based on the initial image and the changed image. If not, control unit 501 is configured to perform the step of controlling camera 504 to again photograph the face of the object to be recognized to obtain a changed image.

Feature image acquisition unit 502 is configured to acquire a facial feature image of the object to be recognized based on the initial image and the changed image.

Feature image acquisition unit 502 specifically includes a differencing operation subunit, which is configured to calculate a difference between the changed image and the initial image, and a determining subunit, which is configured to determine a differential image obtained by the differencing operation as the facial feature image of the object to be recognized.

Image display unit 503 is configured to display the initial image, the changed image, and the facial feature image on the display screen.

The acquisition function in this embodiment utilizes the fact that, in the case that a display pattern of a display screen changes, since features on a user's face have characteristics such as different heights and different positions, different characteristics reflect different shadow characteristics in response to the change of the display pattern, so as to obtain a facial feature image capable of reflecting unique facial characteristics of the user. Further, the facial feature image may also be provided to the user to improve user experience.

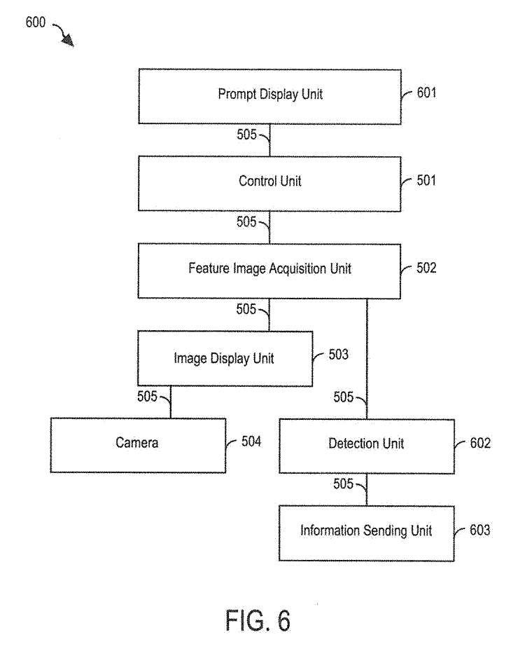

FIG. 6 shows a block diagram that illustrates an example of a facial feature acquisition device 600 in accordance with the present invention. Facial acquisition device 600 is similar to facial acquisition device 500 and, as a result, utilizes the same reference numerals to designate the structures that are common to both devices.

As shown in FIG. 6, facial acquisition device 600 differs from device 500 in that device 600 also includes a prompt display unit 601 that is configured to display a piece of prompt information on the display screen of display unit 503, where the prompt information is used for reminding the object to be recognized to remain still.

Facial acquisition device 600 also differs from device 500 in that device 600 additionally includes a detection unit 602 that is configured to detect, in response to a triggered recognition instruction, whether the object to be recognized is a living body based on the facial feature image.

Detection unit 602 can include a classifier acquisition subunit that is configured to acquire a pre-trained classifier capable of representing facial characteristics of a living body, where the facial characteristics of the living body are characteristics of facial feature locations of a human. Detection unit 602 can also include a judgment subunit that is configured to judge whether shadow features shown in the facial feature image match the facial characteristics of the living body that are shown by the classifier.

Facial acquisition device 600 further differs from device 500 in that device 600 also includes an information sending unit 603 that is configured to, in the case where the object to be recognized is a living body, forward security information inputted by the object to be recognized to a server for verification.

Control unit 501 is configured to control, in response to a triggering of an instruction for acquiring a facial feature image, camera 504 to photograph a face of an object to be recognized to obtain an initial image. Control unit 501 is also configured to control a display screen of display unit 503 to change a display pattern according to a preset pattern changing mode, and control camera 504 to photograph the face of the object to be recognized to obtain a changed image.

Control unit 501 is further configured to judge whether the initial image includes key facial features of the object to be recognized. If so, control unit 501 is configured to perform the step of controlling a display screen of display unit 503 to change a display pattern according to a preset pattern changing mode. If not, control unit 501 is configured to perform the step of controlling camera 504 to photograph a face of an object to be recognized to obtain an initial image.

Control unit 501 is further configured to judge whether the changed image includes key facial features of the object to be recognized. If so, control unit 501 is configured to perform the step of acquiring a facial feature image of the object to be recognized based on the initial image and the changed image. If not, control unit 501 is configured to perform the step of controlling camera 504 to photograph the face of the object to be recognized to obtain a changed image.

Feature image acquisition unit 502 is configured to acquire a facial feature image of the object to be recognized based on the initial image and the changed image.

In this embodiment, multiple sets of initial images and changed images may be collected to obtain multiple facial feature images to perform living body detection, so that the accuracy of living body detection is improved and objects to be recognized being human face photographs can be filtered out, thereby ensuring the security of network data.

The present application further discloses an acquisition device for acquiring a feature image, where the acquisition device is integrated in a server connected to a terminal that has an installed camera. The acquisition device includes a control unit, which is configured to control, in response to a triggering of an instruction for acquiring a facial feature image, the camera to photograph a face of an object to be recognized to obtain an initial image. The control unit is also configured to control a display screen of the acquisition device to change a display pattern according to a preset pattern changing mode, and control the camera to photograph the face of the object to be recognized to obtain a changed image.

The acquisition device also includes a feature image acquisition unit, configured to acquire a facial feature image of the object to be recognized based on the initial image and the changed image.

The acquisition function in this embodiment utilizes the fact that, in the case that a display pattern of a display screen changes, since features on a user's face have characteristics such as different heights and different positions, different characteristics reflect different shadow characteristics in response to the change of the display pattern, so as to obtain a facial feature image capable of reflecting unique facial characteristics of the user. Further, the facial feature image may also be provided to the user to improve user experience.

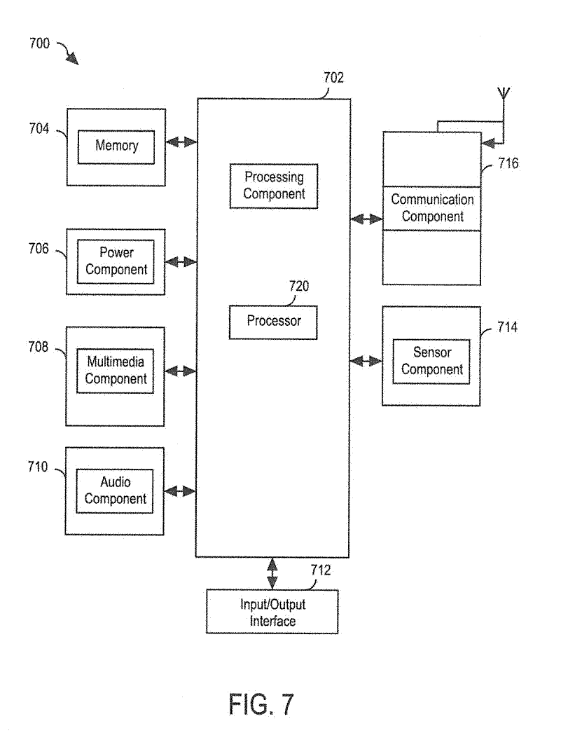

FIG. 7 shows a block diagram that illustrates an example of a facial feature acquisition device 700 in accordance with the present invention. For example, device 700 may be a mobile terminal, a computer, a message sending and receiving apparatus, a tablet apparatus, or various computer apparatuses.

As shown in FIG. 7, device 700 includes a processing component 702, a memory 704, a power component 706, a multimedia component 708, an audio component 710, an input/output (I/O) interface 712, a sensor component 714, and a communication component 716.

Processing component 702 typically controls overall operations of device 700, such as operations associated with display, telephone calls, data communications, camera operations, and recording operations. Processing component 702 may include one or more processors 720 to execute instructions to perform all or some of the steps in the aforementioned methods. Moreover, processing component 702 may include one or more modules which facilitate the interaction between processing component 702 and other components. For example, processing component 702 may include a multimedia module to facilitate the interaction between multimedia component 708 and processing component 702.

Memory 704 is configured to store various types of data to support the operation of device 700. Examples of such data include instructions for any applications or methods operated on device 700, contact data, phone book data, messages, pictures, videos, and so on. Memory 704 may be implemented using any type of volatile or non-volatile storage apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

Power component 706 supplies power to various components of device 700. Power component 706 may include a power management system, one or more power sources, and other components associated with the generation, management, and distribution of power in device 700.

Multimedia component 708 includes a screen providing an output interface between device 700 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure related to the touch or swipe action. In some embodiments, multimedia component 708 includes a front camera and/or a rear camera. The front camera and/or the rear camera may receive external multimedia data while device 700 is in an operation mode, such as a photographing mode or a video mode. Each of the front camera and the rear camera may be a fixed optical lens system or have focus and optical zoom capability.

Audio component 710 is configured to output and/or input audio signals. For example, audio component 710 includes a microphone (MIC) configured to receive an external audio signal when device 700 is in an operation mode, such as a call mode, a recording mode, and a voice recognition mode. The received audio signal may be further stored in memory 704 or sent via communication component 716. In some embodiments, audio component 710 further includes a speaker to output audio signals.

I/O interface 712 provides an interface between the processing component 702 and peripheral interface modules that may be a keyboard, a click wheel, buttons, and the like. The buttons may include, but are not limited to, a home button, a volume button, a starting button, and a locking button.

Sensor component 714 includes one or more sensors to provide state assessment of various aspects for device 700. For example, sensor component 714 may detect an on/off state of device 700, and relative positioning of components, for example, the display and the keypad of device 700. Sensor component 714 may further detect a change in position of the device 700 or a component of device 700, presence or absence of user contact with device 700, an orientation or an acceleration/deceleration of device 700, and a change in temperature of device 700. Sensor component 714 may include a proximity sensor configured to detect the presence of nearby objects without any physical contact. Sensor component 714 may further include a light sensor, such as a CMOS or CCD image sensor, for use in imaging applications. In some embodiments, sensor component 714 may further include an acceleration sensor, a gyroscope sensor, a magnetic sensor, a pressure sensor, or a temperature sensor.

Communication component 716 is configured to facilitate communication in a wired or wireless manner between device 700 and other apparatuses. Device 700 can access a wireless network based on a communication standard, such as WiFi, 2G, or 3G, or a combination thereof. In one exemplary embodiment, communication component 716 receives a broadcast signal or broadcast-related information from an external broadcast management system via a broadcast channel. In one exemplary embodiment, communication component 716 further includes a near field communication (NFC) module to facilitate short-range communications. For example, the NFC module may be implemented based on a radio frequency identification (RFID) technology, an Infrared Data Association (IrDA) technology, an ultra-wideband (UWB) technology, a Bluetooth (BT) technology, and other technologies.

In an exemplary embodiment, device 700 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the aforementioned methods.

In an exemplary embodiment, there is also provided a non-transitory computer-readable storage medium that stores instructions which are executable by processor 720 of device 700 for performing the aforementioned methods. For example, the non-transitory computer-readable storage medium may be a ROM, a random access memory (RAM), a CD-ROM, a magnetic tape, a floppy disk, an optical data storage apparatus, and the like.

A non-transitory computer-readable storage medium, where when instructions in the storage medium are executed by a processor of a mobile terminal, the mobile terminal can perform a method for acquiring a feature image, and the method includes controlling, in response to a triggering of an instruction for acquiring a facial feature image, the camera to photograph a face of an object to be recognized to obtain an initial image. The method also includes controlling a display screen of the mobile terminal to change a display pattern according to a preset pattern changing mode. The method further includes controlling the camera to photograph the face of the object to be recognized to obtain a changed image, and acquiring a facial feature image of the object to be recognized based on the initial image and the changed image.

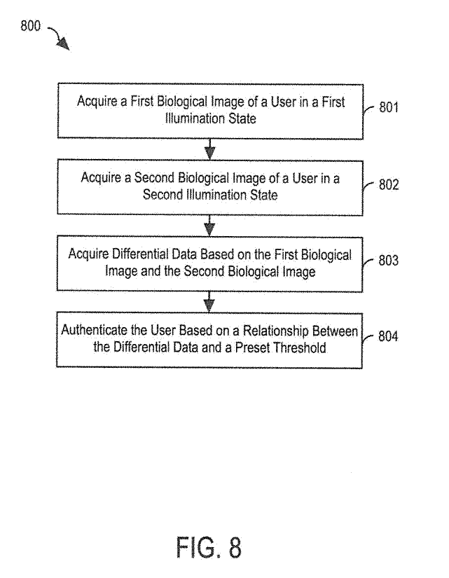

FIG. 8 shows a flow chart that illustrates an example of a method 800 of authenticating a user in accordance with the present invention. As shown in FIG. 8, user authentication method 800 includes the following steps.

Step 801: Acquire a first biological image of a user in a first illumination state.

The user authentication method in this embodiment may be applied to a terminal, or may be applied to a server. The user authentication method being applied to a terminal is used as an example for description below. In this step, first, a camera is used to collect a first biological image of a user in a first illumination state, wherein the first biological image may be a facial image of the user, such as an image including key facial features (the face, nose, mouth, eyes, eyebrows, and so on), and the illumination state is used for representing a phase of a screen display pattern irradiating the user's face in the current environment when the camera collects a facial image. Specifically, reference may be made to the detailed introduction to the screen display image in the embodiments shown in FIG. 2 and FIG. 3, details of which are omitted to avoid repetition.

Step 802: Acquire a second biological image of the user in a second illumination state.

After the first biological image is collected, the phase of the screen display pattern irradiating the user's face in the current environment is changed to obtain a second illumination state different from the first illumination state. A second biological image of the user in the second illumination state is then collected, wherein the image content of the second biological image is the same as the image content of the first biological image. For example, the second biological image is also a facial image of the user.

Step 803: Acquire differential data based on the first biological image and the second biological image.

In this step, a differential image of the second biological image and the first biological image may be specifically used as differential data. For example, pixel values of pixels of the first biological image may be subtracted from corresponding pixel values of pixels of the second biological image to obtain pixel value differences of the pixels. A differential image constituted by the pixel value differences of the pixels is then used as differential data.

Step 804: Authenticate the user based on a relationship between the differential data and a preset threshold.

In this step, a preset threshold may be preset, and the preset threshold can be used for representing biological features (for example, facial features) corresponding to the user when the user is a living body. For example, a classifier may be trained based on a large number of facial feature images of living bodies. Alternately, a facial feature image library can be established based on a large number of facial feature images of living bodies. Then, in this step, the differential image and the preset threshold may be compared, and a comparison result thereof can represent the possibility that the user is a living body. That is, the closer the differential image is to the preset threshold, the more likely the user is a living body. Further, it is judged, based on the comparison result, whether the user may be authenticated, i.e., whether the user is a living body. The authentication is successful if the user is a living body, and the authentication fails if the user is not a living body. For example, if the comparison result of the differential image and the facial feature image library is a similarity higher than 80%, then it indicates that the user corresponding to the differential image is a living body.

In this embodiment, a first biological image and a second biological image are separately acquired by changing an illumination state. Differential data between the second biological image and the first biological image is then obtained, and a user is authenticated based on a relationship between the differential data and a preset threshold. Therefore, the user can be accurately authenticated through biological features reflected by the differential data.

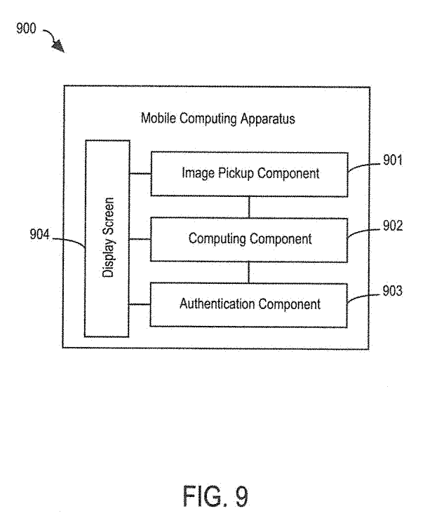

FIG. 9 shows a block diagram that illustrates an example of a mobile computing apparatus 900 in accordance with the present invention. As shown in FIG. 9, apparatus 900 includes an image pickup component 901, a computing component 902, and an authentication component 903.

Image pickup component 901 is configured to acquire a first biological image and a second biological image of a user in a first illumination state and a second illumination state, where the first illumination state and the second illumination state are different.

Computing component 902 is configured to acquire differential data based on the first and second biological images.

Authentication component 903 is configured to authenticate the user based on a relationship between the differential data and a preset threshold.

Mobile computing apparatus 900 may further include a display screen 904, which is configured to receive an input of the user and display a result of the authentication on the user.

At least one of the first illumination state and the second illumination state is formed by a combined action of emitted light from display screen 904 and natural light.

A pattern on the display screen may be generated according to a preset periodical function, and light emitted from display screen 904 is produced.

Mobile computing apparatus 900 in this embodiment separately acquires a first biological image and a second biological image by changing an illumination state, obtains differential data between the second biological image and the first biological image, and then authenticates a user based on a relationship between the differential data and a preset threshold. Therefore, the user can be accurately authenticated through biological features reflected by the differential data.

It should be noted that each embodiment in the present specification is described in a progressive manner, with each embodiment focusing on parts different from other embodiments, and reference can be made to each other for identical and similar parts among various embodiments. With regard to the device embodiments, since the device embodiments are substantially similar to the method embodiments, the description is relatively simple, and reference can be made to the description of the method embodiments for related parts.

Finally, it should be further noted that the term “include,” “comprise,” or any other variation thereof is intended to encompass a non-exclusive inclusion, so that a process, method, article, or apparatus that includes a series of elements includes not only those elements but also other elements not explicitly listed, or elements that are inherent to such a process, method, article, or apparatus. The element defined by the statement “including one . . . ”, without further limitation, does not preclude the presence of additional identical elements in the process, method, article, or apparatus that includes the element.

A method and device for acquiring a feature image, and a user authentication method are provided in the present application and introduced in detail above. The principles and implementation manners of the present application are set forth herein with reference to specific examples, and descriptions of the above embodiments are merely served to assist in understanding the method and essential ideas of the present application. To those of ordinary skill in the art, changes may be made to specific implementation manners and application scopes according to the ideas of the present application.

In view of the above, the contents of the present specification should not be construed as limiting the present application.

What is claimed is:

1. A method for authentication, the method comprising:
displaying a first pattern on a display screen, the first pattern on the display screen illuminating an object;
photographing the object illuminated by the first pattern on the display screen to obtain an initial image of the object;
displaying a second pattern on the display screen, the second pattern on the display screen illuminating the object;
photographing the object illuminated by the second pattern on the display screen to obtain a changed image of the object; and
generating a feature image of the object based on the initial image and the changed image.

2. The method according to claim 1, wherein photographing the object to obtain the initial image includes:
determining whether a captured image includes a number of key features;
identifying the captured image as the initial image when the captured image includes the number of key features; and
re-photographing the object while illuminated with the first pattern until a re-captured image is determined to include the number of key features.

3. The method according to claim 1, wherein photographing the object to obtain the changed image includes:
determining whether a captured image includes a number of key features;
identifying the captured image as the changed image when the captured image includes the number of key features; and
re-photographing the object while illuminated with the second pattern until a re-captured image is determined to include the number of key features.

4. The method according to claim 1, wherein the first pattern is generated according to a preset two-dimensional periodical function.

5. The method according to claim 4, wherein the second pattern is generated by phase inverting the first pattern.

6. The method according to claim 1, wherein the feature image of the object is generated by subtracting values of pixels of the initial image from values of corresponding pixels of the changed image to obtain values of pixels of the feature image.

7. The method according to claim 1, further comprising detecting, in response to a triggered recognition instruction, whether the object is a living body based on the feature image.

8. The method according to claim 7, further comprising forwarding security information to a server for user verification when the object is detected to be a living body, the security information being inputted by the object into a terminal.

9. The method according to claim 7, wherein detecting whether the object is a living body includes:
acquiring a pre-trained classifier capable of representing facial characteristics of a living body, wherein the facial characteristics of a living body are characteristics of facial feature positions of a human; and
judging whether shadow features shown in the facial feature image match the facial characteristics of the living body shown by the classifier.

10. The method according to claim 1, further comprising displaying prompt information on the display screen before photographing the object, the prompt information reminding the object to remain still.

11. The method according to claim 1, further comprising displaying the initial image, the changed image, and the feature image on the display screen.

12. A non-transitory computer-readable medium having computer executable instructions stored thereon that when executed by a processor cause the processor to implement a method of authentication, the method comprising:
controlling a display screen to display a first pattern on the display screen, the first pattern on the display screen illuminating an object;
controlling a camera to photograph the object illuminated by the first pattern on the display screen to obtain an initial image of the object;
controlling the display screen to display a second pattern on the display screen, the second pattern on the display screen illuminating the object;
controlling the camera to photograph the object illuminated by the second pattern on the display screen to obtain a changed image of the object; and
generating a feature image of the object based on the initial image and the changed image.

13. The medium of claim 12, wherein the method further comprises:
determining whether a captured image includes a number of key features;
identifying the captured image as the initial image when the captured image includes the number of key features; and
causing the camera to re-photograph the object while illuminated with the first pattern until a re-captured image is determined to include the number of key features.

14. The medium of claim 12, wherein the method further comprises:
determining whether a captured image includes a number of key features;
identifying the captured image as the changed image when the captured image includes the number of key features; and
causing the camera to re-photograph the object while illuminated with the second pattern until a re-captured image is determined to include the number of key features.

15. The medium of claim 12, wherein:
the first pattern is generated according to a preset two-dimensional periodical function;
the second pattern is generated by phase inverting the first pattern; and
the feature image of the object is generated by calculating a difference between the changed image and the initial image.

16. The medium of claim 12, wherein the method further comprises detecting, in response to a triggered recognition instruction, whether the object is a living body based on the feature image.

17. The medium of claim 16, wherein the method further comprises forwarding security information to a server for user verification when the object is detected to be a living body, the security information being inputted by the object into a terminal.

18. A device comprising:
a display screen;
a camera; and
a processor coupled to the display screen and the camera, the processor to:
control the display screen to display a first pattern on the display screen, the first pattern on the display screen illuminating an object;
control the camera to photograph the object illuminated by the first pattern on the display screen to obtain an initial image of the object;
control the display screen to display a second pattern on the display screen, the second pattern on the display screen illuminating the object;
control the camera to photograph the object illuminated by the second pattern on the display screen to obtain a changed image of the object; and
generate a feature image of the object based on the initial image and the changed image.

19. The device of claim 18, wherein the processor to further:
determine whether a captured image includes a number of key features;
identify the captured image as the initial image when the captured image includes the number of key features; and
control the camera to re-photograph the object while illuminated with the first pattern until a re-captured image is determined to include the number of key features.

20. The device of claim 18, wherein the processor to further:
determine whether a captured image includes a number of key features;
identify the captured image as the changed image when the captured image includes the number of key features; and
control the camera to re-photograph the object while illuminated with the second pattern until a re-captured image is determined to include the number of key features.

21. The device of claim 18, wherein:
the first pattern is generated according to a preset two-dimensional periodical function;
the second pattern is generated by phase inverting the first pattern; and
the feature image of the object is generated by calculating a difference between the changed image and the initial image.

22. The device of claim 21, wherein the processor to further:
detect, in response to a triggered recognition instruction, whether the object is a living body based on the feature image; and
forward security information to a server for user verification when the object is detected to be a living body, the security information being inputted by the object into a terminal.
